(19) United States
(12) Patent Application Publication
(10) Pub. No.: US 2017/0300533 A1
(43) Pub. Date: Oct. 19, 2017

(54) METHOD AND SYSTEM FOR CLASSIFICATION OF USER QUERY INTENT FOR MEDICAL INFORMATION RETRIEVAL SYSTEM

(71) Applicant: Baidu USA LLC, Sunnyvale, CA (US)

(72) Inventors: Weide Zhang, Santa Clara, CA (US); Richard Chun-Ching Wang, Sunnyvale, CA (US); Bocong Liu, Sunnyvale, CA (US); Weicheng Zhu, Sunnyvale, CA (US)

(21) Appl. No.: 15/099,514

(22) Filed: Apr. 14, 2016

(51) Int. Cl. G06F 17/30; G06N 99/00; G06N 7/00

(52) U.S. Cl. CPC G06F 17/30525; G06N 7/005; G06N 99/005

(57) ABSTRACT

According to one embodiment, a set of predetermined queries are collected, where each of the predetermined queries is associated with a predetermined category (e.g., particular medical category or particular type of Web sites). For each of the predetermined queries, the predetermined query is annotated using an annotation dictionary corresponding to the predetermined category. One or more features are extracted from the predetermined query based on annotation of the predetermined query. A classification model corresponding to the predetermined category is trained and generated based on the predetermined queries and features associated with the predetermined queries. The classification model is utilized to classify users for information retrieval.

### FIELD OF THE INVENTION

Embodiments of the present invention relate generally to searching content. More particularly, embodiments of the invention relate to training and creating classification models and using the same for classifying users for medical information retrieval.

### BACKGROUND

Most search engines typically perform searching of Web pages during their operation from a browser running on a client device. A search engine receives a search term entered by a user and retrieves a search result list of Web pages associated with the search term. The search engine displays the search results as a series of subsets of a search list based on certain criteria. General criteria that is used during a search operation is whether the search term appears fully or partly on a given webpage, the number of times the search string appears in the search result, alphabetical order, etc. Further, the user can decide to open a link by clicking on the mouse button to open and browse. Some of the user interactions with the search results and/or user information may be monitored and collected by the search engine to provide better searches subsequently.

Typically, in response to a search query, a search is performed to identify and retrieve a list of content items. The content items are then returned to a search requester. Dependent upon the quality of the search engine, the content items turned to the user may or may not be what the user actually wanted. In order to provide better content services to users, it is important to know or predict what the users want, especially in the field of searching medical information. Semantic understanding of medical search queries is important to the underlying retrieval system. Conventional search retrieval systems only use tokenized queries to match keywords, which do not reflect the real intent of search queries. User's medical queries can reflect the user's interest in getting an answer in different aspects of medical phases. There has been a lack of efficient ways to determine query intent of users.

### BRIEF DESCRIPTION OF THE DRAWINGS

Embodiments of the invention are illustrated by way of example and not limitation in the figures of the accompanying drawings in which like references indicate similar elements.

FIGS. 1A and 1B are block diagram illustrating an example of system configuration for searching images according to some embodiments of the invention.

FIG. 2 is a block diagram illustrating an example of a user classification model training system according to one embodiment of the invention.

FIG. 3 is a diagram illustrating a processing flow of training a classification model according to one embodiment of the invention.

FIG. 4 is a diagram illustrating a process for annotation and feature extraction according to one embodiment of the invention.

FIG. 5 is a block diagram illustrating a content searching system according to one embodiment of the invention.

FIG. 6 is a diagram illustrating a processing flow for searching content using classification models according to one embodiment of the invention.

FIG. 7 is a flow diagram illustrating a process of training classification models according to one embodiment of the invention.

FIG. 8 is a flow diagram illustrating a process of classifying users using classification models according to one embodiment of the invention.

FIG. 9 is a block diagram illustrating a data processing system according to one embodiment.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to some embodiments, a user classification system (e.g., medical query intent classification) is provided to classify medical search queries into user categories, which may be used to derive user intents. User categories or intents can be utilized as fine-grained categories of medical practices phases where query's answer are mapped to. The classification system utilizes offline known sets of data to train classification models to categorize queries into a set of predetermined categories (e.g., intent categories). A set of annotation dictionaries are built for predetermined categories, such as, for example in the medical information retrieval field, treatment, disease, symptoms, etc. Annotation dictionaries are built based on data crawled from Web sites that are associated with the predetermined categories. During training, features are determined from known search queries, which represent the existence of certain features. Features for queries include at least word n-gram, predetermined categories (e.g., medical categories), and relative token position information. Thus each query is converted into a set of features used for training.

According to one aspect of the invention, a set of predetermined queries are collected, where each of the predetermined queries is associated with a predetermined category (e.g., particular medical category or particular type of Web sites). For each of the predetermined queries, the predetermined query is annotated using an annotation dictionary corresponding to the predetermined category. One or more features are extracted from the predetermined query based on annotation of the predetermined query. A classification model corresponding to the predetermined category is trained and generated based on the predetermined queries and features associated with the predetermined queries. The classification model is utilized to classify users for information retrieval.

According to another aspect of the invention, a first search query is received form a client device of a user, the first search query having one or more keywords. In response to the first search query, the keywords of the search query are annotated using a set of predetermined annotation dictionaries. Each annotation dictionary corresponds to one of predetermined categories. Features are extracted from the annotated keywords of the first search query. The user is classified by applying one or more classification models to the extracted features. A search is performed in a content database to retrieve a list of one or more content items based on a classification of the user. The list of one or more content items is transmitted to the client device.

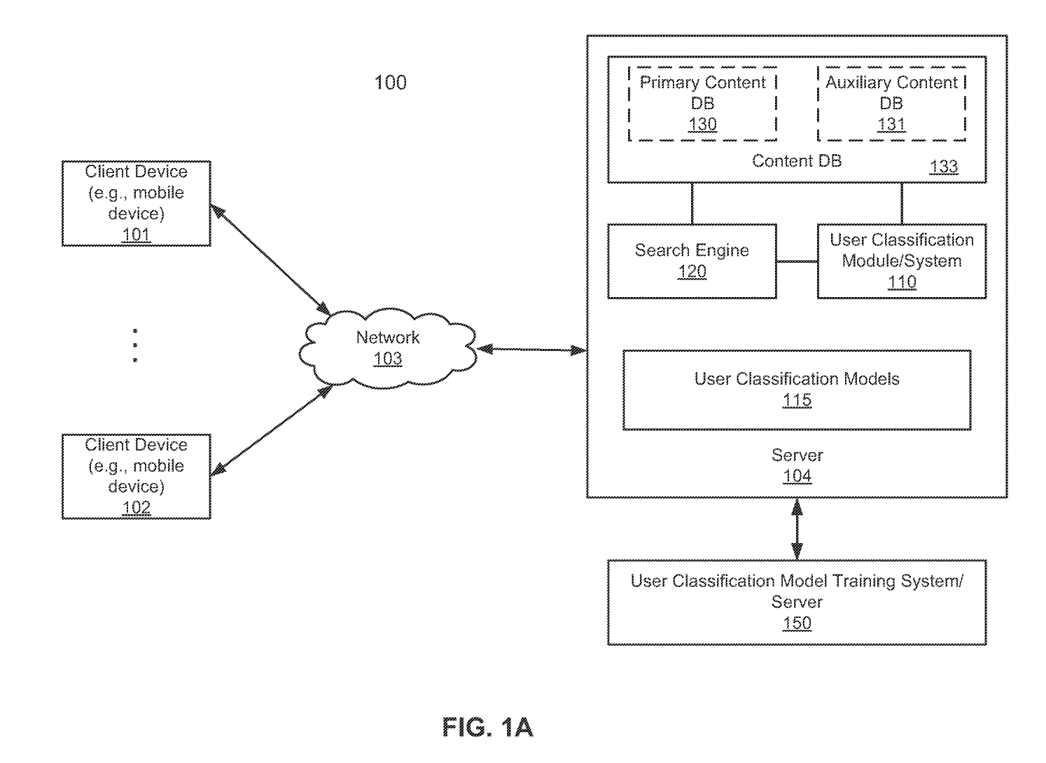

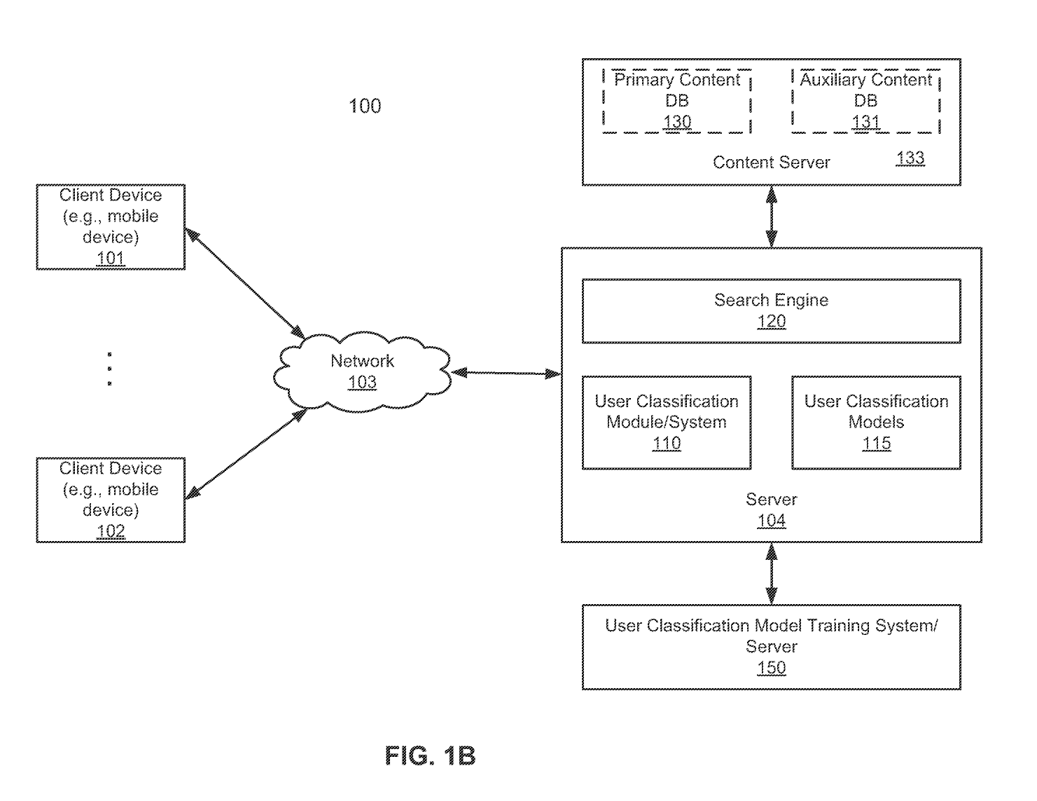

FIGS. 1A and 1B are block diagram illustrating an example of system configuration for searching images according to some embodiments of the invention. Referring to FIG. 1A, system 100 includes, but is not limited to, one or more client devices 101-102 communicatively coupled to server 104 over network 103. Client devices 101-102 may be any type of client devices such as a personal computer (e.g., desktops, laptops, and tablets), a “thin” client, a personal digital assistant (PDA), a Web enabled appliance, a Smartwatch, or a mobile phone (e.g., Smartphone), etc. Network 103 may be any type of networks such as a local area network (LAN), a wide area network (WAN) such as the Internet, or a combination thereof, wired or wireless.

Server 104 may be any kind of servers or clusters of servers, such as Web or cloud servers, application servers, backend servers, or a combination thereof. In one embodiment, server 104 includes, but is not limited to, search engine 120, image selection module or system 110, and image selection rules or models 115. Server 104 further includes an interface (not shown) to allow a client such as client devices 101-102 to access resources or services provided by server 104. The interface may include a Web interface, an application programming interface (API), and/or a command line interface (CLI).

For example, a client, in this example, a user application of client device 101 (e.g., Web browser, mobile application), may send a search query to server 104 and the search query is received by search engine 120 via the interface over network 103. In response to the search query, search engine 120 extracts one or more keywords (also referred to as search terms) from the search query. Search engine 120 performs a search in content database 133, which may include primary content database 130 and/or auxiliary content database 131, to identify a list of content items that are related to the keywords. Primary content database 130 (also referred to as a master content database) may be a general content database, while auxiliary content database 131 (also referred to as a secondary content database) may be a special content database. Search engine 120 returns a search result page having at least some of the content items in the list to client device 101 to be presented therein. Search engine 120 may be a Baidu® search engine available from Baidu, Inc. or alternatively, search engine 120 may represent a Google® search engine, a Microsoft Bing™ search engine, a Yahoo® search engine, or some other search engines.

A search engine, such as a Web search engine, is a software system that is designed to search for information on the World Wide Web. The search results are generally presented in a line of results often referred to as search engine results pages. The information may be a mix of Web pages, images, and other types of files. Some search engines also mine data available in databases or open directories. Unlike web directories, which are maintained only by human editors, search engines also maintain real-time information by running an algorithm on a web crawler.

Web search engines work by storing information about many web pages, which they retrieve from the hypertext markup language (HTML) markup of the pages. These pages are retrieved by a Web crawler, which is an automated Web crawler which follows every link on the site. The search engine then analyzes the contents of each page to determine how it should be indexed (for example, words can be extracted from the titles, page content, headings, or special fields called meta tags). Data about web pages are stored in an index database for use in later queries. The index helps find information relating to the query as quickly as possible.

When a user enters a query into a search engine (typically by using keywords), the engine examines its index and provides a listing of best-matching web pages according to its criteria, usually with a short summary containing the document's title and sometimes parts of the text. The index is built from the information stored with the data and the method by which the information is indexed. The search engine looks for the words or phrases exactly as entered. Some search engines provide an advanced feature called proximity search, which allows users to define the distance between keywords. There is also concept-based searching where the research involves using statistical analysis on pages containing the words or phrases you search for. As well, natural language queries allow the user to type a question in the same form one would ask it to a human.

Referring back to FIG. 1A, according to one embodiment, in response to a search query received at server 104 from a client device, in this example, client device 101, search engine 120 performs a search in content database 133, such as primary content database 130 and/or auxiliary content database 131, to generate a list of content items. Each of the content items may be associated with a particular Web page of a particular Web site of a particular content provider via a uniform resource link (URL) and/or a uniform resource identifier (URI). In one embodiment, primary content database 130 stores general content items that have been collected by network crawlers (e.g., unsponsored content). Auxiliary content database 135 stores specific or special content items that are associated with specific, known, or predetermined content providers (e.g., sponsored content). Alternatively, content database 133 may be implemented as a single database without distinguishing primary content database 131 from auxiliary content database 132.

Network crawlers or Web crawlers are programs that automatically traverse the network's hypertext structure. In practice, the network crawlers may run on separate computers or servers, each of which is configured to execute one or more processes or threads that download documents from URLs. The network crawlers receive the assigned URLs and download the documents at those URLs. The network crawlers may also retrieve documents that are referenced by the retrieved documents to be processed by a content processing system (not shown) and/or search engine 120. Network crawlers can use various protocols to download pages associated with URLs, such as hypertext transport protocol (HTTP) and file transfer protocol (FTP).

Referring to FIG. 1A, server 104 further includes user classification module or system 110 to classify users who initiated search queries using one or more user classification models 115 to determine a type or category of users. The category or type of a user can be utilized to determine what the user likely does or what information the user would like to receive (e.g., user intent). Based on the user classification, a search can then be performed in content database 133, for example, for particular types of content associated with the user classification (e.g., types or categories of users). As a result, a better search result (e.g., special content or sponsored content specifically configured for certain types of users or user intent) can be provided to the users and satisfaction of the users can be improved.

User classification models 115 (also simply referred to as models) are trained and generated by user classification model training system 150 (also simply referred to as a training system), which may be implemented as a separate server over a network or alternatively be integrated with server 104. Models 115 may be trained and generated offline by training system 150, loaded into server 104, and periodically updated from training system 150. Each of models 115 corresponds to one of a number of predetermined categories, classes of users, or types of information (e.g., medical information). Each of models 115 may represent one of the predetermined categories of information that users are likely interested in or would like to receive in response to a search query.

In the field of information retrieval, it is important to know or predict what the user really likes to receive. One of the most popular searches on the Web is medical information searching. For the purpose of illustration, the techniques described throughout this application are described with respect to medical information retrieval. However, the techniques can equally applicable to other types of information retrieval. In one embodiment, each of models 115 has been trained to classify and map a user to one of the predetermined categories, i.e., medical categories in response to a search query initiated by the user. In one embodiment, the predetermined categories of information include: 1) medical treatment, 2) medical decease, 3) medical symptom, 4) medicine, 5) medical department or facility, 6) medical laboratory, 7) price, and 8) unknown (e.g., a catchall category).

For each of the predetermined categories, a model is trained and generated based on a set of known search queries corresponding to the predetermined category. The set of known search queries may be collected from a set of known Web sites associated with that particular predetermined category. In one embodiment, certain keywords in a search query and how these keywords appear within the search query can be utilized to train the model to derive a user intent. These processes are referred to as offline processes to create models 115. The models 115 are then loaded into sever 104 to process search queries in real-time, referred to herein as online processes.

In response to a search query from a client device of a user such as client device 101, the search query is fed into each of the models 115. Each of models 115 provides an indicator indicating a likelihood the user is associated with a predetermined category corresponding to that particular model. In other words, each of models 115 predicts based on the search query whether the user is likely interested in a particular category of information associated with that particular model. In one embodiment, each of models 115 provides a probability that the user is interested in receiving information of the corresponding category. Based on the probabilities provided by models 115, user classification or user intent is determined, for example, based on the category with the highest probability. Thereafter, certain types of content can be identified and returned to the user based on the user classification or user intent (e.g., targeted content), which may reflect what the user really wants to receive. In one embodiment, if a probability predicted by a model is above a predetermined threshold (e.g., 70%), the corresponding search query is treated as a known query and may be added to the set of known query associated with that model for subsequent training purposes.

For example, according to one embodiment, in response to a search query, search engine 120 performs a search in primary content database 130 to identify and retrieve a list of general content items. In addition, user classification system 110 classifies the user based on the search query using one or more of classification models 115 determine a category or class of the user or category or class of information sought by the user, which may represent a user intent of the user. Based on the user classification, a search may be performed in auxiliary content database 131 to identify and retrieve a list of special content items (e.g., sponsored content). Thereafter, a search result having both the general and special content items is returned to the user. Here, the special content items are specific content targeting the user based on the user intent, which may be more accurate or closer to what the user really wants.

Note that the configuration of server 104 has been described for the purpose of illustration only. Server 104 may be a Web server to provide a frontend search service to a variety of end user devices. Alternatively server 104 may be an application server or backend server that provides specific or special content search services to a frontend server (e.g., Web server or a general content server. Other architectures or configurations may also be applicable. For example, as shown in FIG. 1B, content database 133 may be maintained and hosted in a separate server as a content server over a network. Server 133 may be a Web server, an application server, or a backend server. Content server 133 may be organized and provided by the same entity or organization as of server 104. Alternatively, content server 133 may be maintained or hosted by separate entities or organizations (e.g., third-party content providers), which are responsible for collecting contents in content databases 130-131 and their metadata. Also note that content database/server 133 may include primary content database 130 and auxiliary content database 131. Primary content database 130 may also be implemented or maintained in a separate content server, referred to as a primary content server. Similarly, auxiliary content database 131 may be implemented or maintained in a separate content sever, referred to as an auxiliary content server.

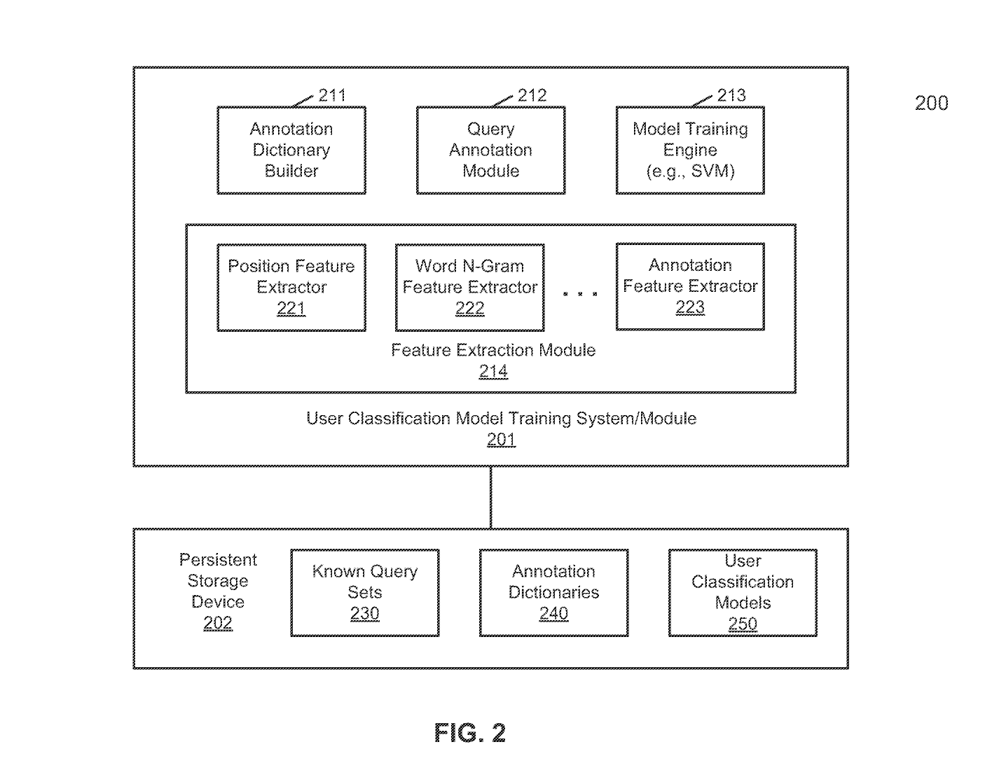

FIG. 2 is a block diagram illustrating an example of a user classification model training system according to one embodiment of the invention. System 200 may be implemented as part of model training system or server 150 of FIGS. 1A-1B. Referring to FIG. 2, according to one embodiment, system 200 includes model training system/module 201, which may be implemented in software, hardware, or a combination thereof. For example, model training system 201 may be implemented in software loaded in a memory and executed by a processor (not shown), which may be communicatively coupled to persistent storage device 202 storing known query sets 230, annotation dictionaries 240, and user classification models 250.

In one embodiment, model training system 201 includes annotation dictionary builder 211, query annotation module 212, feature extraction module 214, and model training engine 213. Annotation dictionary builder 211 builds a set of annotation dictionaries 240 that store words or phrases associated with the corresponding predetermined categories. Query annotation module 212 annotates a set of known queries 230 using annotation dictionaries 240. Feature extraction module 214 is to extract a set of predetermined features from the annotated queries. In one embodiment, the features to be extracted include position features, word n-gram features, and annotation features, which may be extracted by position feature extractor 221, word n-gram feature extractor 222, and annotation feature extractor 223, respectively.

Model training engine 213 then trains and generates user classification models 250 based on the annotated queries with extracted features. Model training engine 213 may be a support vector machine (SVM) compatible training engine or any other machine-learning systems. Models 250 may be SVM compatible models. In machine learning, SVMs (also referred to as support vector networks) are supervised learning models with associated learning algorithms that analyze data used for classification and regression analysis. Given a set of training examples, each marked for belonging to one of two categories, an SVM training algorithm builds a model that assigns new examples into one category or the other, making it a non-probabilistic binary linear classifier. An SVM model is a representation of the examples as points in space, mapped so that the examples of the separate categories are divided by a clear gap that is as wide as possible. New examples are then mapped into that same space and predicted to belong to a category based on which side of the gap they fall on.

In addition to performing linear classification, SVMs can efficiently perform a non-linear classification using what is called the kernel trick, implicitly mapping their inputs into high-dimensional feature spaces. When data are not labeled, a supervised learning is not possible, and an unsupervised learning is required, that would find natural clustering of the data to groups, and map new data to these formed groups. The clustering algorithm which provides an improvement to the support vector machines is called support vector clustering and is often used in applications either when data is not labeled or when only some data is labeled as a preprocessing for a classification pass.

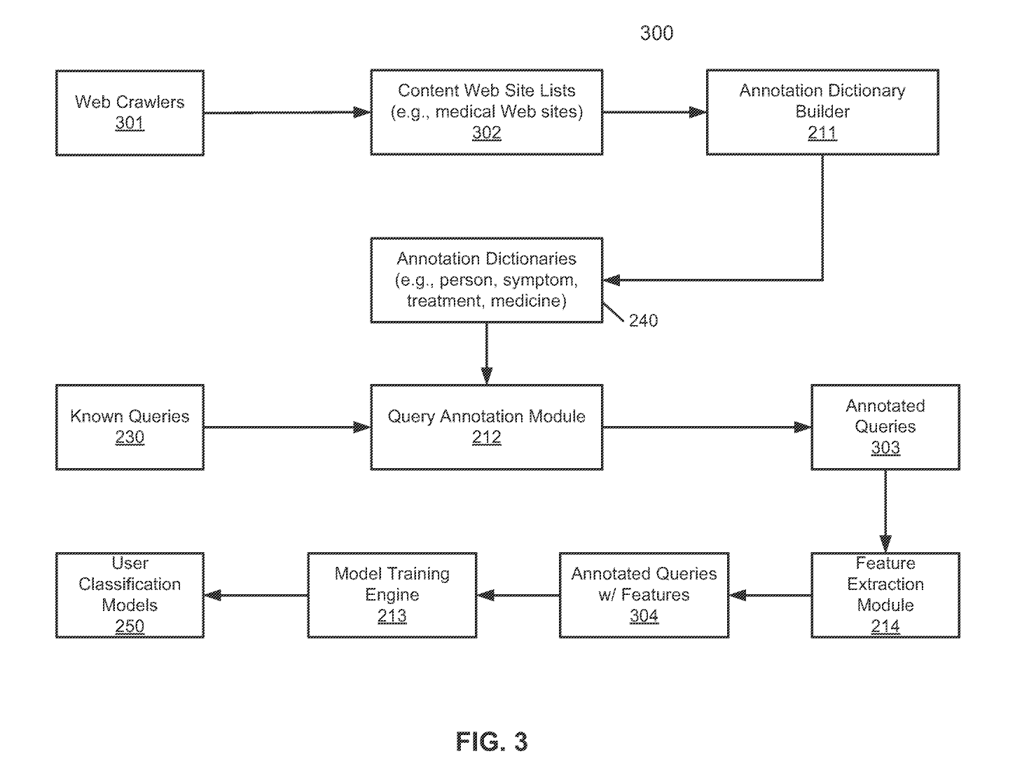

In one embodiment, referring now to FIGS. 2 and 3, annotation dictionary builder 211 builds a set of annotation dictionaries 240 corresponding to a set of predetermined categories (e.g., medical treatment, medical decease, medical symptom, medicine, medical department or facility, medical laboratory, price, and/or unknown) based on a set of known words and/or phases corresponding to each of the predetermined categories. Each of annotation dictionaries stores the specific words and/or phases that have been frequently used in domains related to the corresponding category. The words and phrases associated with a particular category may be collected by Web crawlers 301 from many Web sites 302 that belong to that category.

Once annotation dictionaries 240 have been created, query annotation module 212 annotates a set of known queries 230 using annotation dictionaries 240. In one embodiment, one or more keywords are extracted from each of known queries 230. For each of the keywords, annotation module 212 determines whether the keyword is included in any one or more of annotation dictionaries. If a keyword appears in an annotation dictionary, annotation module 212 annotates or marks that keyword is associated with a category corresponding to that particular annotation dictionary. Note that a keyword may be associated with more than one category. As a result, a set of annotated queries 303 is generated.

A set of one or more features are extracted from annotated queries 303 by feature extraction module 214. In one embodiment, position feature extractor 221 extracts position features of one or more keywords in a search query. A position feature indicates a position of a keyword within the search query, which can be a number of words counting (e.g., offset) from the start or end of the search query. In addition, word n-gram feature extractor 222 extracts word n-gram features from search query. In the fields of computational linguistics and probability, an n-gram is a contiguous sequence of n items from a given sequence of text or speech. The items can be phonemes, syllables, letters, words or base pairs according to the application. Furthermore, annotation feature extractor 223 extracts annotation features from the annotated search query. An annotation feature indicates that a search query includes a keyword belonging to a particular annotation dictionary. As a result, a set of annotated queries with the extracted features 304 is generated. Annotated queries with features 304 are then fed into model training engine 213 to train a set of classification models 250.

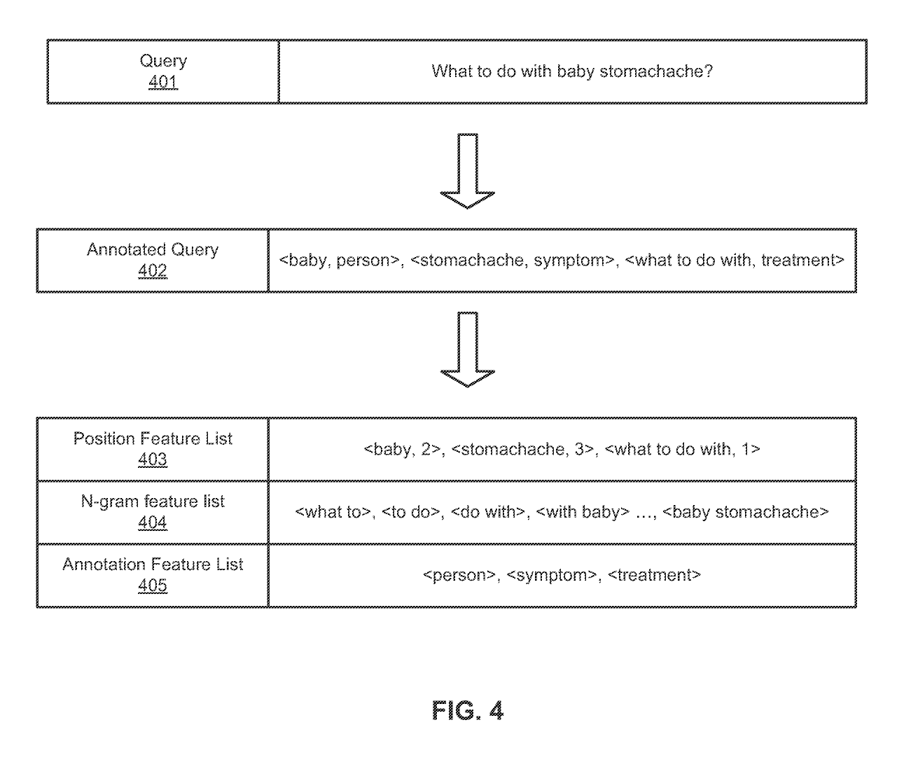

FIG. 4 is a diagram illustrating a process for annotation and feature extraction according to one embodiment of the invention. The process as shown can be utilized to create a classification model offline or searching using a classification model (which will be described in detail further below) online. Referring to FIG. 4, search query 401, either received online for searching or offline for modeling, includes a statement of “what to do with baby stomachache?” Query 401 is then annotated using a set of predetermined annotation dictionaries to generate annotated query 402. In this example, the annotation dictionaries include dictionaries for person/patient, treatment, decease, symptom, medicine, department, laboratory, price, and unknown. As a result, the term of “baby” is annotated with category “person” or “patient.” The term of “stomachache” is annotated with category “symptom.” The term of “what to do with” is annotated with category “treatment.”

Features of annotated query 402 are then extracted, including position features 403, n-gram features 404 (in this example, 2-gram), and annotation features 405. Position features 403 indicate the position of each word or phrase in the query. In this example, the term of “what to do with” is positioned at the first position; the term of “baby” is at the second position; and the term of “stomachache” is at the third or last position. Annotation features indicate which of the categories associated with the annotation dictionaries include at least one word or term of the query, in this example, person, symptom, and treatment. The annotated query 402 and features 403-405 are then used to train a model or to search online using a model.

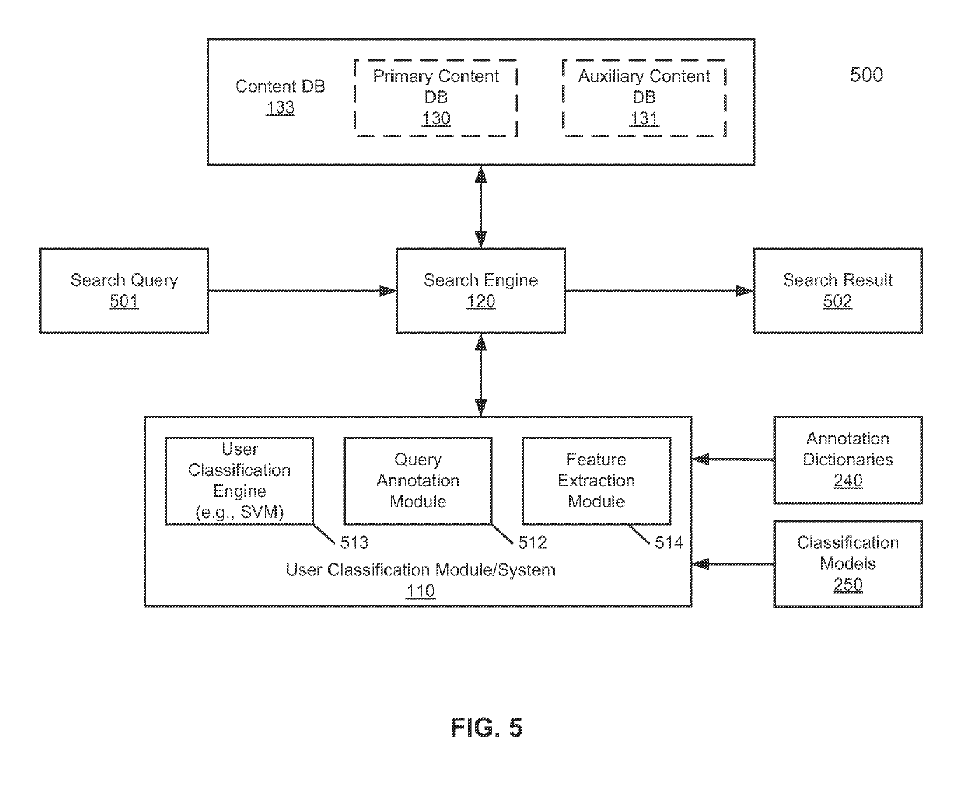

FIG. 5 is a block diagram illustrating a content searching system according to one embodiment of the invention. System 500 may be considered as an online searching system based on user intent that is determined using one or more classification models, which were created using an offline model training system as described above. Referring to FIG. 5, according to one embodiment, user classification module or system 110 includes user classification engine 513, query annotation module 512, and feature extraction module 514. User classification engine 513 may be an SVM compatible engine, which may be the same or similar to model training engine 214 of FIG. 2. Query annotation module 512 may be the same or similar annotation module 212 of FIG. 2. Feature extraction module 514 may be the same or similar to feature extraction module 214 of FIG. 2, including position feature extractor 221, word n-gram feature extractor 222, and annotation feature extractor 223.

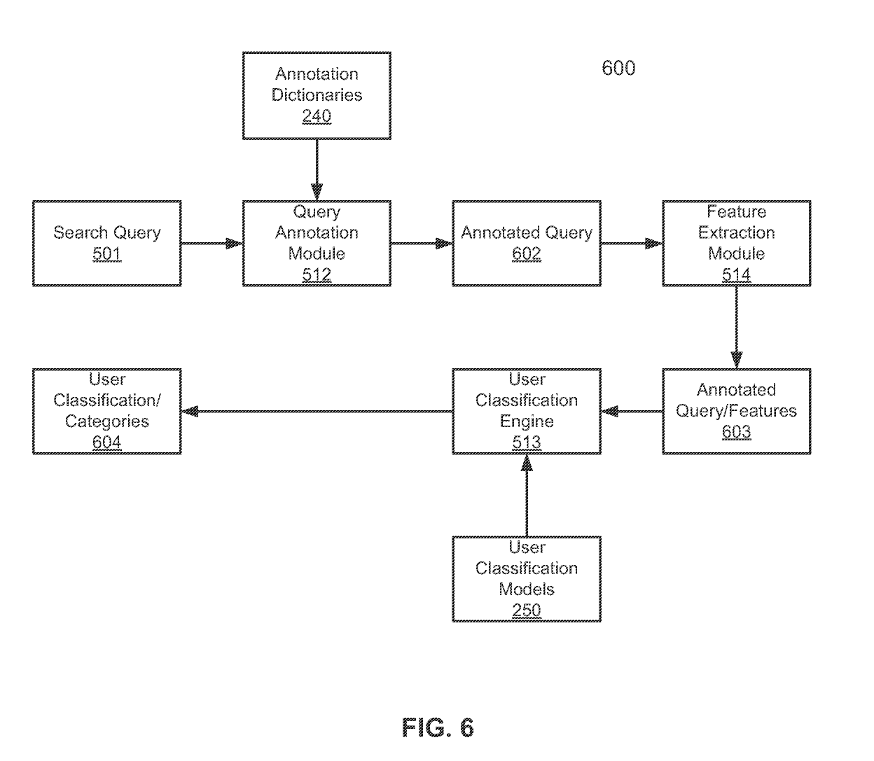

In one embodiment, referring now to FIGS. 5 and 6, in response to a search query 501, search engine 120 invokes user classification system 110 to classify a user who initiated search query 501 (e.g., user intent), using one or more classification models 250. In one embodiment, query annotation module 512 annotates search query 501 (e.g., query 401 of FIG. 4) using annotation dictionaries 240 to generate annotated query 602 (e.g., annotated query 402 of FIG. 4). Feature extraction module 514 extracts features from annotated query 602, including position features (e.g., features 403 of FIG. 4), n-gram features (e.g., features 404), and annotation features (e.g., features 405 of FIG. 4) as described above, which generates annotated query with features 603. User classification engine 513 classifies the user based on annotated query with features 603 using classification models 250 to generate user classification or categories 604. Based on the user classification 604, search engine 120 performs a search in content database 133 to identify and retrieve a list of content items to generate search result 502. The search result is then returned to the user. In one embodiment, if a probability predicted by a model is above a predetermined threshold (e.g., 70%), the corresponding search query is treated as a known query and may be added to the set of known query associated with that model for subsequent training purposes.

Note that the annotation process and the feature extraction process are the same or similar to those described above with respect to FIGS. 2-4. In one embodiment, a single SVM engine is utilized as classification engine 513 and training engine 213. During the offline training process, sets of known queries are fed into the SVM engine to generate a set of models. During the online searching process, the SVM engine loads a binary of each of the models and processes a search query received online to output an indicator representing a likelihood, such as, a probability, of which the user is associated with corresponding category. As a result, the SVM generates a set of probabilities corresponding to the set of categories. One of the categories having the highest probability will be selected for searching purposes. In the example as shown in FIG. 4, the user most likely seeks a treatment for baby's stomachache. Thus, a search for medical treatments for baby stomachache will be performed, because that is the category of medical information the user is most likely interested in receiving.

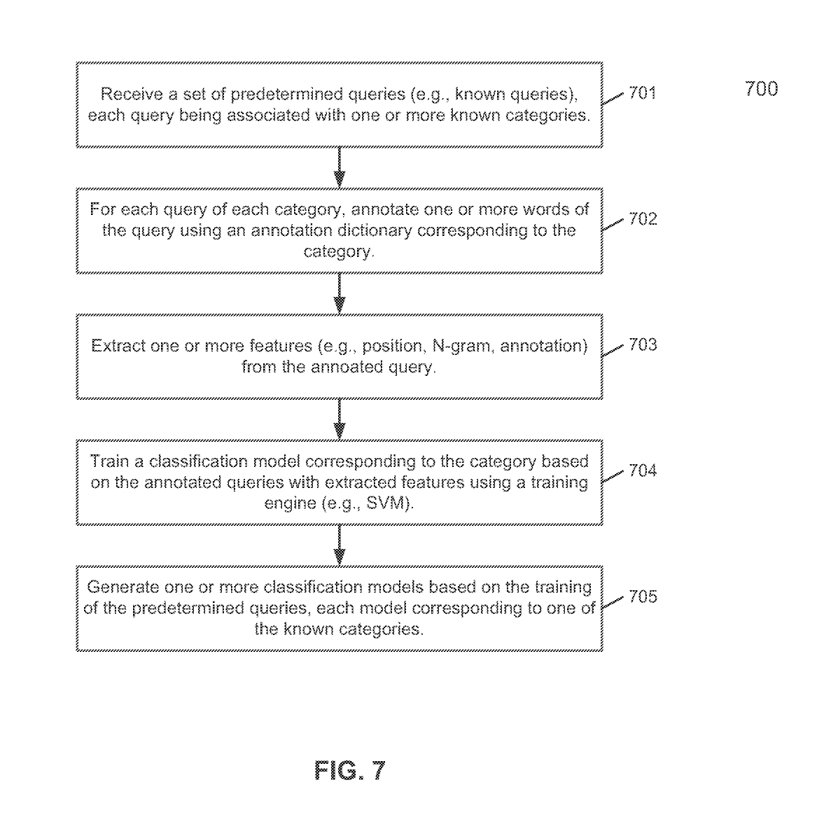

FIG. 7 is a flow diagram illustrating a process of training classification models according to one embodiment of the invention. Process 700 may be performed by processing logic that includes hardware (e.g. circuitry, dedicated logic, etc.), software (e.g., embodied on a non-transitory computer readable medium), or a combination thereof. For example, process 700 may be performed by system 200 of FIG. 2. Referring to FIG. 7, at block 701, processing logic receives a set of predetermined queries (e.g., known queries), each query being associated with one or more known categories. At block 702, for each of the query of each category, processing logic annotates one or more keywords of the query using an annotation dictionary corresponding to the category. At block 703, processing logic extracts one or more features (e.g., position, n-gram, and annotation features) from the annotated query. At block 704, processing logic trains a classification model corresponding to the category based on the annotated query with extracted features using a training engine (e.g., SVM). At block 705, processing logic generate one or more classification models based on the training of the predetermined queries. Each model corresponds to one of the predetermined categories.

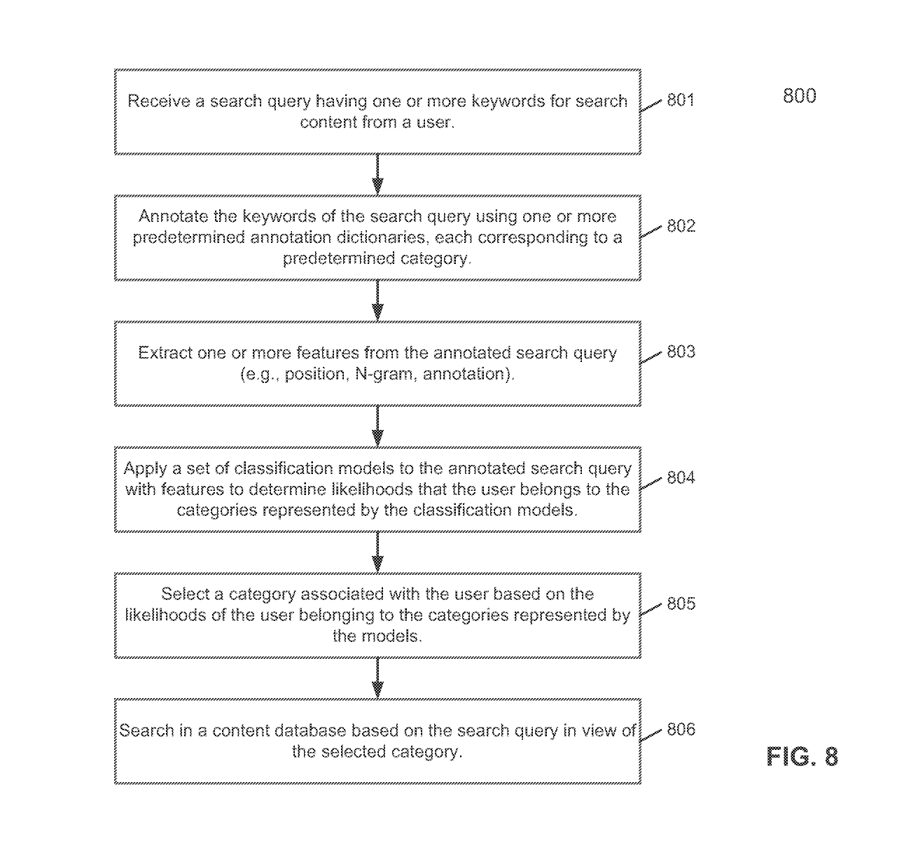

FIG. 8 is a flow diagram illustrating a process of classifying users using classification models according to one embodiment of the invention. Process 800 may be performed by processing logic that includes hardware (e.g. circuitry, dedicated logic, etc.), software (e.g., embodied on a non-transitory computer readable medium), or a combination thereof. For example, process 800 may be performed by system 500 of FIG. 5. Referring to FIG. 8, at block 801, processing logic receives from a user a search query having one or more keywords for searching content. At block 802, processing logic annotates the keywords of the search query using one or more annotate dictionaries. Each annotation dictionary stores terms or words corresponding to a predetermined category. At block 803, processing logic extracts one or more features from the annotated search query (e.g., position, n-gram, annotation features). At block 804, processing logic applies a set of classification models to the annotated query and the features to determine likelihoods (e.g., probabilities) that the user belongs to the categories represented by the classification models. At block 805, a category having the highest likelihood is selected to be associated with the user. At block 806, a search is performed in a content database in view of the selected category of the user (e.g., user intent).

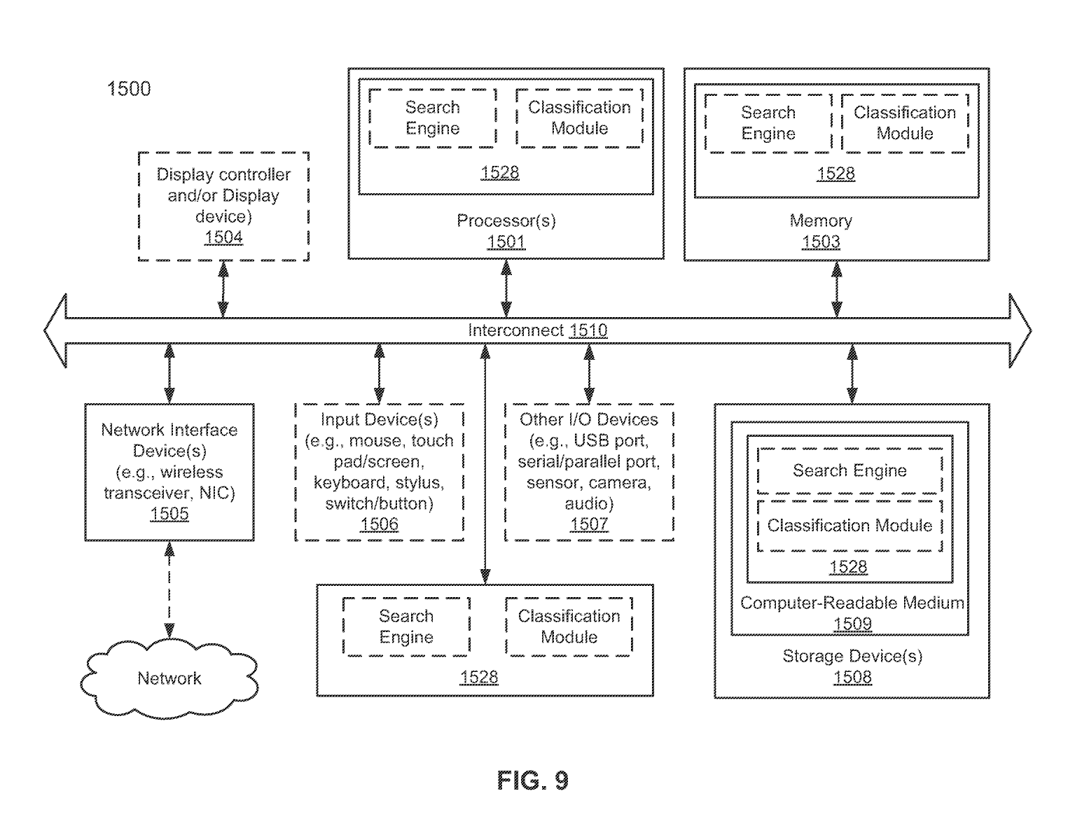

FIG. 9 is a block diagram illustrating an example of a data processing system which may be used with one embodiment of the invention. For example, system 1500 may represents any of data processing systems described above performing any of the processes or methods described above, such as, for example, a client device or a server described above, such as, for example, server 104, content server 133, classification model training system 150 as described above.

System 1500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system.

Note also that system 1500 is intended to show a high level view of many components of the computer system. However, it is to be understood that additional components may be present in certain implementations and furthermore, different arrangement of the components shown may occur in other implementations. System 1500 may represent a desktop, a laptop, a tablet, a server, a mobile phone, a media player, a personal digital assistant (PDA), a Smartwatch, a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 1500 includes processor 1501, memory 1503, and devices 1505-1508 via a bus or an interconnect 1510. Processor 1501 may represent a single processor or multiple processors with a single processor core or multiple processor cores included therein. Processor 1501 may represent one or more general-purpose processors such as a microprocessor, a central processing unit (CPU), or the like. More particularly, processor 1501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 1501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 1501, which may be a low power multi-core processor socket such as an ultra-low voltage processor, may act as a main processing unit and central hub for communication with the various components of the system. Such processor can be implemented as a system on chip (SoC). Processor 1501 is configured to execute instructions for performing the operations and steps discussed herein. System 1500 may further include a graphics interface that communicates with optional graphics subsystem 1504, which may include a display controller, a graphics processor, and/or a display device.

Processor 1501 may communicate with memory 1503, which in one embodiment can be implemented via multiple memory devices to provide for a given amount of system memory. Memory 1503 may include one or more volatile storage (or memory) devices such as random access memory (RAM), dynamic RAM (DRAM), synchronous DRAM (SDRAM), static RAM (SRAM), or other types of storage devices. Memory 1503 may store information including sequences of instructions that are executed by processor 1501, or any other device. For example, executable code and/or data of a variety of operating systems, device drivers, firmware (e.g., input output basic system or BIOS), and/or applications can be loaded in memory 1503 and executed by processor 1501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 1500 may further include IO devices such as devices 1505-1508, including network interface device(s) 1505, optional input device(s) 1506, and other optional IO device(s) 1507. Network interface device 1505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 1506 may include a mouse, a touch pad, a touch sensitive screen (which may be integrated with display device 1504), a pointer device such as a stylus, and/or a keyboard (e.g., physical keyboard or a virtual keyboard displayed as part of a touch sensitive screen). For example, input device 1506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 1507 may include an audio device. An audio device may include a speaker and/or a microphone to facilitate voice-enabled functions, such as voice recognition, voice replication, digital recording, and/or telephony functions. Other IO devices 1507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 1507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 1510 via a sensor hub (not shown), while other devices such as a keyboard or thermal sensor may be controlled by an embedded controller (not shown), dependent upon the specific configuration or design of system 1500.

To provide for persistent storage of information such as data, applications, one or more operating systems and so forth, a mass storage (not shown) may also couple to processor 1501. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 1501, e.g., via a serial peripheral interface (SPI). This flash device may provide for non-volatile storage of system software, including a basic input/output software (BIOS) as well as other firmware of the system.

Storage device 1508 may include computer-accessible storage medium 1509 (also known as a machine-readable storage medium or a computer-readable medium) on which is stored one or more sets of instructions or software (e.g., module, unit, and/or logic 1528) embodying any one or more of the methodologies or functions described herein. Module/unit/logic 1528 may represent any of the components described above, such as, for example, a search engine, an encoder, an interaction logging module as described above. Module/unit/logic 1528 may also reside, completely or at least partially, within memory 1503 and/or within processor 1501 during execution thereof by data processing system 1500, memory 1503 and processor 1501 also constituting machine-accessible storage media. Module/unit/logic 1528 may further be transmitted or received over a network via network interface device 1505.

Computer-readable storage medium 1509 may also be used to store the some software functionalities described above persistently. While computer-readable storage medium 1509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media, or any other non-transitory machine-readable medium.

Module/unit/logic 1528, components and other features described herein can be implemented as discrete hardware components or integrated in the functionality of hardware components such as ASICS, FPGAs, DSPs or similar devices. In addition, module/unit/logic 1528 can be implemented as firmware or functional circuitry within hardware devices. Further, module/unit/logic 1528 can be implemented in any combination hardware devices and software components.

Note that while system 1500 is illustrated with various components of a data processing system, it is not intended to represent any particular architecture or manner of interconnecting the components; as such details are not germane to embodiments of the present invention. It will also be appreciated that network computers, handheld computers, mobile phones, servers, and/or other data processing systems which have fewer components or perhaps more components may also be used with embodiments of the invention.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method for generating classification models for searching content, the method comprising:
receiving a set of predetermined queries, each of the predetermined queries being associated with a predetermined category;
for each of the predetermined queries,
annotating the predetermined query using an annotation dictionary corresponding to the predetermined category, and
extracting one or more features from the predetermined query based on annotation of the predetermined query; and
training and generating a classification model corresponding to the predetermined category based on the predetermined queries and features associated with the predetermined queries, wherein the classification model is utilized to classify users for information retrieval.

2. The method of claim 1, wherein the predetermined category is one of a plurality of predetermined categories, wherein the method further comprises:
for each of the predetermined categories, iteratively performing operations of receiving a set of predetermined queries, annotating each of the predetermined queries, and extracting features from each of the predetermined queries; and
generating a plurality of classification models, each corresponding to one of the plurality of predetermined categories.

3. The method of claim 1, wherein the annotation dictionary contains a set of keywords associated with the predetermined category, and wherein the set of keywords were collected from one or more predetermined content servers that are associated with the predetermined category.

4. The method of claim 1, wherein extracting one or more features from the predetermined query comprises extracting one or more position features from one or more keywords of the predetermined query, wherein each position feature indicates a position of a keyword within the predetermined query.

5. The method of claim 4, further comprising extracting one or more word N-gram features from one or more keywords the predetermined query.

6. The method of claim 5, further comprising extracting one or more annotation features from one or more keywords of the predetermined query, wherein each annotation feature indicates whether a corresponding keyword is found in the annotation dictionary.

7. The method of claim 2, further comprising:
receiving a first search query form a client device of a user, the first search query having one or more keywords;
in response to the first search query, annotating the keywords of the first search query using a plurality of annotation dictionaries;
extracting features from the annotated keywords of the first search query; and
classifying the user by applying the plurality of classification models to the extracted features.

8. The method of claim 7, further comprising:
searching in a content database to retrieve a list of one or more content items based on a classification of the user; and
transmitting the list of one or more content items to the client device.

9. A non-transitory machine-readable medium having instructions stored therein, which when executed by a processor, cause the processor to perform operations of training classification models, the operations comprising:
receiving a set of predetermined queries, each of the predetermined queries being associated with a predetermined category;
for each of the predetermined queries,
annotating the predetermined query using an annotation dictionary corresponding to the predetermined category, and
extracting one or more features from the predetermined query based on annotation of the predetermined query; and
training and generating a classification model corresponding to the predetermined category based on the predetermined queries and features associated with the predetermined queries, wherein the classification model is utilized to classify users for information retrieval.

10. The non-transitory machine-readable medium of claim 9, wherein the predetermined category is one of a plurality of predetermined categories, wherein the operations further comprise:
for each of the predetermined categories, iteratively performing operations of receiving a set of predetermined queries, annotating each of the predetermined queries, and extracting features from each of the predetermined queries; and
generating a plurality of classification models, each corresponding to one of the plurality of predetermined categories.

11. The non-transitory machine-readable medium of claim 9, wherein the annotation dictionary contains a set of keywords associated with the predetermined category, and wherein the set of keywords were collected from one or more predetermined content servers that are associated with the predetermined category.

12. The non-transitory machine-readable medium of claim 9, wherein extracting one or more features from the predetermined query comprises extracting one or more position features from one or more keywords of the predetermined query, wherein each position feature indicates a position of a keyword within the predetermined query.

13. The non-transitory machine-readable medium of claim 12, wherein the operations further comprise extracting one or more word N-gram features from one or more keywords the predetermined query.

14. The non-transitory machine-readable medium of claim 13, wherein the operations further comprise extracting one or more annotation features from one or more keywords of the predetermined query, wherein each annotation feature indicates whether a corresponding keyword is found in the annotation dictionary.

15. The non-transitory machine-readable medium of claim 10, wherein the operations further comprise:
receiving a first search query form a client device of a user, the first search query having one or more keywords;
in response to the first search query, annotating the keywords of the first search query using a plurality of annotation dictionaries;
extracting features from the annotated keywords of the first search query; and
classifying the user by applying the plurality of classification models to the extracted features.

16. The non-transitory machine-readable medium of claim 15, wherein the operations further comprise:
searching in a content database to retrieve a list of one or more content items based on a classification of the user; and
transmitting the list of one or more content items to the client device.

17. A data processing system, comprising:
a processor; and
a memory coupled to the processor, the memory storing instructions, which when executed by the processor, cause the processor to perform operations of training classification models, the operations including
receiving a set of predetermined queries, each of the predetermined queries being associated with a predetermined category;
for each of the predetermined queries,
annotating the predetermined query using an annotation dictionary corresponding to the predetermined category, and
extracting one or more features from the predetermined query based on annotation of the predetermined query; and
training and generating a classification model corresponding to the predetermined category based on the predetermined queries and features associated with the predetermined queries, wherein the classification model is utilized to classify users for information retrieval.

18. The system of claim 17, wherein the predetermined category is one of a plurality of predetermined categories, wherein the operations further comprise:
for each of the predetermined categories, iteratively performing operations of receiving a set of predetermined queries, annotating each of the predetermined queries, and extracting features from each of the predetermined queries; and
generating a plurality of classification models, each corresponding to one of the plurality of predetermined categories.

19. The system of claim 17, wherein the annotation dictionary contains a set of keywords associated with the predetermined category, and wherein the set of keywords were collected from one or more predetermined content servers that are associated with the predetermined category.

20. The system of claim 17, wherein extracting one or more features from the predetermined query comprises extracting one or more position features from one or more keywords of the predetermined query, wherein each position feature indicates a position of a keyword within the predetermined query.

21. The system of claim 20, wherein the operations further comprise extracting one or more word N-gram features from one or more keywords the predetermined query.

22. The system of claim 21, wherein the operations further comprise extracting one or more annotation features from one or more keywords of the predetermined query, wherein each annotation feature indicates whether a corresponding keyword is found in the annotation dictionary.

23. The system of claim 18, wherein the operations further comprise:
receiving a first search query form a client device of a user, the first search query having one or more keywords;
in response to the first search query, annotating the keywords of the first search query using a plurality of annotation dictionaries;
extracting features from the annotated keywords of the first search query; and
classifying the user by applying the plurality of classification models to the extracted features.

24. The system of claim 23, wherein the operations further comprise:
searching in a content database to retrieve a list of one or more content items based on a classification of the user; and
transmitting the list of one or more content items to the client device.

25. A computer-implemented method for searching content, the method comprising:
receiving a first search query form a client device of a user, the first search query having one or more keywords;
in response to the first search query, annotating the keywords of the search query using a plurality of annotation dictionaries, each annotation dictionary corresponding to one of a plurality of categories;
extracting features from the annotated keywords of the first search query;
classifying the user by applying a plurality of classification models to the extracted features;
searching in a content database to retrieve a list of one or more content items based on a classification of the user; and
transmitting the list of one or more content items to the client device.

26. The method of claim 25, wherein each of the annotation dictionaries contains a list of a plurality of keywords that belong to a corresponding predetermined category, and wherein the set of keywords were collected from one or more predetermined content servers that are associated with the predetermined category.

27. The method of claim 25, wherein extracting one or more features from the predetermined query comprises extracting one or more position features from one or more keywords of the predetermined query, wherein each position feature indicates a position of a keyword within the predetermined query.

28. The method of claim 27, further comprising extracting one or more word N-gram features from one or more keywords the predetermined query.

29. The method of claim 28, further comprising extracting one or more annotation features from one or more keywords of the predetermined query, wherein each annotation feature indicates whether a corresponding keyword is found in the annotation dictionary.

30. The method of claim 25, wherein classifying the user by applying the plurality of classification models to the extracted features comprises generating a plurality of indicators corresponding to the plurality of predetermined categories, each indicator indicating a probability of the search query belonging to a corresponding predetermined category.

31. The method of claim 30, wherein the classification of the user is determined based on a predetermined category having a highest probability.
